(19) United States
(12) Patent Application Publication
(10) Pub. No.: US 2023/0103828 A1
(43) Pub. Date: Apr. 6, 2023

(54) SADDLE RIDING VEHICLE

(71) Applicant: KAWASAKI MOTORS, LTD., Hyogo (JP)

(72) Inventors: Ryosuke OHORI, Hyogo (JP); Tetsuji YAMAMOTO, Hyogo (JP); Masaki NISHIYABU, Hyogo (JP); Takuya NOAMI, Hyogo (JP); Shusei UENO, Hyogo (JP); Shinji IKEDA, Hyogo (JP)

(73) Assignee: KAWASAKI MOTORS, LTD., Hyogo (JP)

(21) Appl. No.: 17/954,531

(22) Filed: Sep. 28, 2022

(30) Foreign Application Priority Data
Oct. 1, 2021 (JP) 2021-163080
Aug. 4, 2022 (JP) 2022-124535

(51) Int. Cl. B62J 17/10; B62K 11/04

(52) U.S. Cl. CPC B62J 17/10; B62K 11/04; B62M 7/04

(57) ABSTRACT

A saddle riding vehicle includes: an engine disposed between a front wheel and a rear wheel; a fuel tank disposed above the engine; a generator mounted to a crankshaft of the engine; and an inverter that supplies output of the generator to a battery. The inverter is disposed behind a head pipe, above a crankcase and below the fuel tank.

### CROSS REFERENCE TO THE RELATED APPLICATION

This application is based on and claims Convention priority to Japanese patent application No. 2021-163080, filed Oct. 1, 2021 and Japanese patent application No. 2022-124535, filed Aug. 4, 2022, the entire disclosures of all of which are herein incorporated by reference as a part of this application.

### BACKGROUND OF THE INVENTION

### Field of the Invention

The present application relates to a saddle riding vehicle including an engine, a generator mounted to a crankshaft of the engine, and an inverter that supplies output of the generator to a battery.

### Description of Related Art

Some saddle riding vehicles such as motorcycles include an inverter that supplies regenerative output from a motor to a battery for the purpose of energy regeneration during deceleration (see, for example, WO 2014/102851A1).

In saddle riding vehicles such as motorcycles, however, it may be difficult to secure an installation space for the inverter because they have a limited space for equipment in some cases.

### SUMMARY OF THE INVENTION

The disclosure of the present application provides a saddle riding vehicle in which an inverter can be arranged compactly.

In one embodiment of the present disclosure, a saddle riding vehicle includes: an engine disposed between a front wheel and a rear wheel; a fuel tank disposed above the engine; a generator mounted to a crankshaft of the engine; and an inverter that supplies output of the generator to a battery, wherein the inverter is disposed behind a head pipe, above the crankcase and below the fuel tank.

According to the saddle riding vehicle of the present disclosure, the inverter is disposed behind the head pipe, above the crankcase and below the fuel tank. Thus, the inverter can be disposed compactly in a limited space within the saddle riding vehicle.

The present disclosure encompasses any combination of at least two features disclosed in the claims and/or the specification and/or the drawings. In particular, any combination of two or more of the appended claims should be equally construed as included within the scope of the present disclosure.

### BRIEF DESCRIPTION OF THE DRAWINGS

The present disclosure will be more clearly understood from the following description of preferred embodiments thereof, when taken in conjunction with the accompanying drawings. However, the embodiments and the drawings are given only for the purpose of illustration and explanation, and are not to be taken as limiting the scope of the present disclosure in any way whatsoever, which scope is to be determined by the appended claims. In the accompanying drawings, like reference numerals are used to denote like or corresponding parts throughout the several views;

FIG. 1 is a side view showing a motorcycle that is a type of saddle riding vehicle according to a first embodiment of the present disclosure;

FIG. 2 is a plan view of the motorcycle;

FIG. 3 is a side view of a front part of the motorcycle;

FIG. 4 is an enlarged front view of the front part of the motorcycle;

FIG. 5 is a side view of a front half of a vehicle body frame of the motorcycle;

FIG. 6 is a side view showing wiring of an inverter in the motorcycle;

FIG. 7 is a side view showing a front part of a motorcycle that is a type of saddle riding vehicle according to a second embodiment of the present disclosure;

FIG. 8 is a side view showing a vehicle body frame and an engine of the motorcycle;

FIG. 9 is a front view showing the front part of the motorcycle in an enlarged manner;

FIG. 10 is a side view showing the configuration without the cowling, as compared with the configuration shown in FIG. 7; and

FIG. 11 is a horizontal sectional view of the front part of the vehicle body.

### DESCRIPTION OF THE EMBODIMENTS

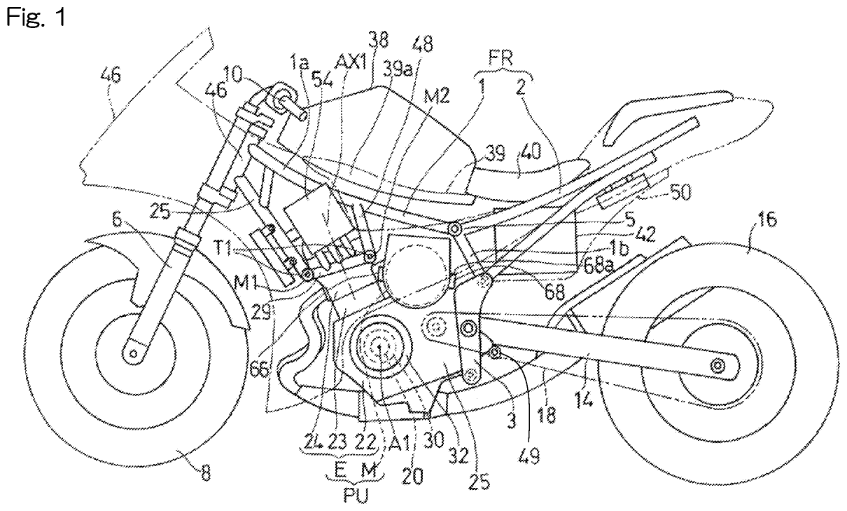

Hereinafter, a preferable embodiment of the present disclosure will be described with reference to the drawings. FIG. 1 is a side view showing a motorcycle that is a type of saddle riding vehicle according to a first embodiment of the present disclosure. As used herein, the “left” and “right” correspond to the “left” and “right” when viewed by a driver riding on the vehicle, respectively. The “front” and “rear” correspond to the “front” and “rear” in the moving direction of the vehicle.

The motorcycle of the present embodiment is a hybrid vehicle including an engine E that is a first power source, and a motor M that is a second power source. That is, depending on the driving mode, the motorcycle of the present embodiment drives using only the engine E that is an internal combustion engine, or using only the motor M that is an electric motor, or using both the engine E and the motor M simultaneously.

The motorcycle includes a vehicle body frame FR that is constituted by a pipe frame. The vehicle body frame FR includes a main frame 1 which constitutes the front half and a rear frame 2 which constitutes the rear half. The main frame 1 extends rearward and diagonally downward from a head pipe 4 at the front end and then is bent downward to extend in the vertical direction. The rear frame 2 extends rearward from a rear part of the main frame 1.

The head pipe 4 supports a front fork 6. A front wheel 8 is supported by a lower end portion of the front fork 6, and a handlebar 10 is attached to an upper end portion of the front fork 6.

A swing arm bracket 3 is provided to a rear end portion of the main frame 1. The swing arm bracket 3 supports swing arms 14 in such a way that the swing arms 14 are allowed to vertically swing. A rear wheel 16 is attached to rear end portions of the swing arms 14.

The engine E is disposed below the main frame 1 between the front wheel 8 and the rear wheel 16 and is supported by the vehicle body frame FR. Power of the engine E is transmitted from a sprocket of an engine output shaft OS to the rear wheel 16 through a power transmission member 18, so that the rear wheel 16 is driven. The power transmission member 18 is, for example, a drive chain. However, the power transmission member 18 is not limited to a drive chain.

The engine E includes a crankshaft 20 extending in the vehicle widthwise direction, a crankcase 22 supporting the crankshaft 20 in a rotatable manner, a cylinder 23 protruding upward from the crankcase 22, and a cylinder head 24 located above the cylinder. In the present embodiment, the axis AX of the cylinder 23 and the cylinder head 24 is inclined forward as it extends upward. The motor M is disposed above the crankcase 22.

The respective front portions and rear portions of the cylinder 23 and the cylinder head 24 are supported by the vehicle body frame FR. Specifically, the vehicle body frame FR includes a first frame piece 25 extending in the vertical direction in front of the cylinder head 24 and a second frame piece 26 extending in the vertical direction behind the cylinder head 24. The first frame piece 25 extends downward in an inclined manner to the rear from a part of the head pipe 4 located below the main frame 1. The second frame piece 26 extends downward in a slightly inclined manner to the rear from a middle portion of the main frame 1 in the front-to-rear direction.

The first frame piece 25 and the second frame piece 26 are provided with a first mount part M1 and a second mount part M2, respectively, at their lower end portions. The first mount part M1 and the second mount part M2 are connected by a first connecting member 29 extending in the front-to-rear direction. The first connecting member 29 is located on the outer side in the vehicle widthwise direction with respect to the cylinder 23. The front portion of the cylinder head 24 is supported by the first mount part M1 by using a fastening member such as a bolt, and the rear portion of the cylinder head 24 is supported by the second mount part M2 by using a fastening member such as a bolt. That is, the first frame piece 25 and the first mount part M1 constitute a first engine support part 27 that supports the front portion of the cylinder 23 and the cylinder head 24 of the engine E, and the second frame piece 26 and the second mount part M2 constitute a second engine support part 28 that supports the rear portion of the cylinder 23 and the cylinder head 24.

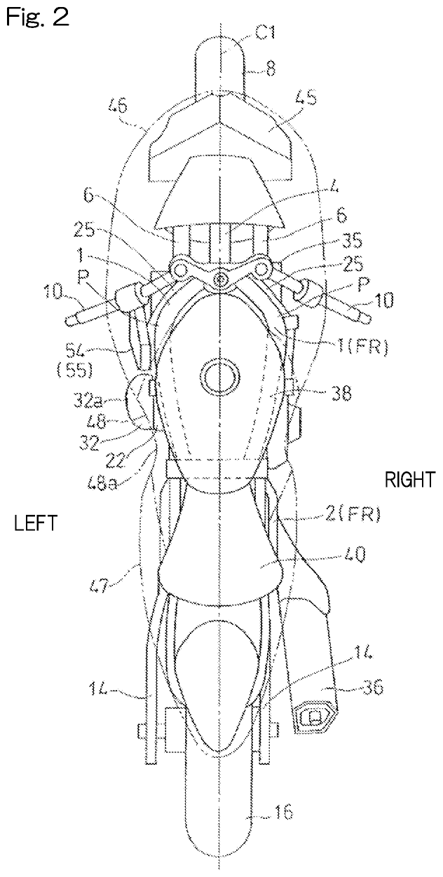

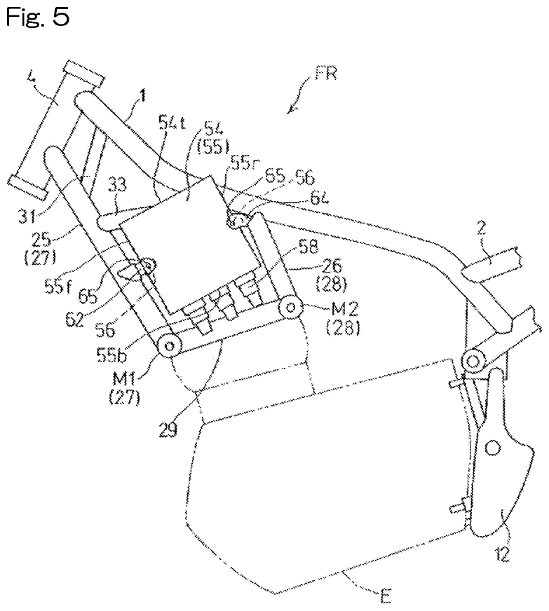

More specifically, in a plan view of FIG. 2, the main frame 1 extends rearward from the head pipe 4 in an outwardly inclined manner in the vehicle widthwise direction and then is bent at bending parts P to extend rearward in an inwardly inclined manner in the vehicle widthwise direction. The first frame piece 25 extends in an outwardly inclined manner in the vehicle widthwise direction as it extends rearward from the head pipe 4. As shown in FIG. 5, the main frame I and the first frame piece 25 are connected by a second connecting member 31 and a third connecting member 33. The second connecting member 31 connects a front end portion of the main frame 1 to a front end portion of the first frame piece 25, and the third connecting member 33 connects a middle portion of the main frame 1 in the front-to-rear direction to a rear portion of the first frame piece 25.

A generator 30 is disposed on one side of the crankshaft 20, i.e., at one axial end of the crankshaft. In the present embodiment, a generator 30 is disposed on the left side of the crankshaft. The generator 30 of the present embodiment is a generator with starter motor function (Integrated Starter Generator). The generator 30 generates electrical power from the power of the engine E, i.e., from rotation of the crankshaft 20. A generator cover 32 is removably attached to the left side surface of the crankcase 22. The generator cover 32 covers the generator 30 from the outer side in the vehicle widthwise direction.

An exhaust pipe 34 is connected to an exhaust port 24a on the front side of the cylinder head 24. The exhaust pipe 34 extends rearward below the engine E to be connected to an exhaust muffler 36 on the right side of the rear wheel 16. The exhaust muffler 36 reduces the noise of exhaust from the exhaust pipe 34 before it is discharged outside. A radiator 35 is disposed in front of the engine E. The radiator 35 uses the incoming wind to cool the engine cooling water.

A fuel tank 38 is disposed in an upper part of the main frame 1, and a seat 40 on which a driver sits is attached to the rear frame 2. The fuel tank 38 is disposed right above the engine E, behind the head pipe 4 and in front of the seat 40.

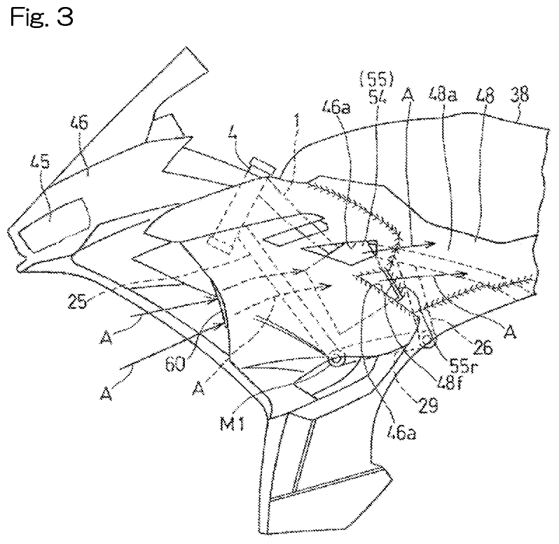

A cowling 46 made of a resin, which is illustrated with double dotted lines, is disposed on the front half of the vehicle body. The cowling 46 of the present embodiment covers an area in front of the head pipe 4 to an area lateral to the engine E. A headlight 45 is attached to the cowling 46. As shown in FIG. 3, an exhaust air port 46a is formed in an upper rear part of the cowling 46.

As shown in FIG. 1, a pair of rear cowls 47 made of a resin, which are illustrated with double dotted lines, are disposed at the rear of the cowling 46. The rear cowls 47 cover the gaps between the seat 44 and the rear frame 2 from the outer lateral sides.

A pair of left and right knee grip covers 48, which are illustrated with double dotted lines, are disposed below the fuel tank 38. The knee grip covers 48 cover areas located forward of and below the seat 40 from outer lateral sides. As shown in FIG. 2, each of the knee grip covers 48 includes a recessed part 48a which is recessed inward in the vehicle widthwise direction. The recessed parts 48a constitute knee grip parts which are held between the knees of a driver while driving. The knee grip parts 48a cover, from the outer lateral sides, the lower areas of the central part to the rear part of the fuel tank 42 shown in FIG. 1.

Each knee grip part 48a is disposed forward with respect to a line connecting a step 49 to the front end of the seat 44 and on a side wall lower part of the fuel tank 42. The knee grip parts 48a are, for example, located above the engine E. In the present embodiment, the knee grip parts 48a are arranged in areas above the driving motor M and the cylinder head 24. The knee grip parts 48a may be arranged in areas from the boundary between the seat 44 and the fuel tank 38 to the middle position of the fuel tank 38 in the front-to-rear direction.

A rear fender 50, which is illustrated with double dotted lines, is disposed below the rear cowl 47 and above the rear wheel 16. The rear fender 50 protects a driver from splashing of mud, water, and the like by the rear wheel 16. A battery 52 is housed inside the rear fender 50. That is, the rear fender 50 constitutes a battery case for housing the battery 52. The battery 52 is disposed below the seat 40 and above the crankcase 22. The battery 52 of the present embodiment is a 48-V lithium-ion battery. However, the battery 52 is not limited to this example. Inside the rear fender, a control battery 53 is housed at the rear of the driving battery 52.

The motorcycle of the present embodiment includes, in an upper lateral position with respect to the engine E, an inverter 54 that supplies output of the generator 30 to the battery 52. The inverter 54 of the present embodiment is an inverter with an integrated DC/DC converter. That is, the inverter 54 of the present embodiment supplies output of the generator 30 to the 48-V driving battery 52 and, for example, converts the output to 12 V to supply power to the battery 53 for control power supply.

As shown in FIG. 5, the inverter 54 of the present embodiment includes a main body case 55 having a rectangular shape in a side view. The main body case 55 has a front side 55f and a rear side 55r each extending rearward in an inclined manner from the upper end to the lower end, as well as an upper side 55t and a lower side 55b each extending upward in an inclined manner from the front end to the rear end.

Each of the front side 55f and the rear side 55r includes an insertion hole 56 facing in the vehicle widthwise direction in the middle portion in the vertical direction. The lower side 55b includes three connectors 58. The connectors 58 are connected with a first wire connecting to the generator 30, a second wire connecting to the battery 52 for the motor M, and a third wire connecting to the battery 53 for control power supply.

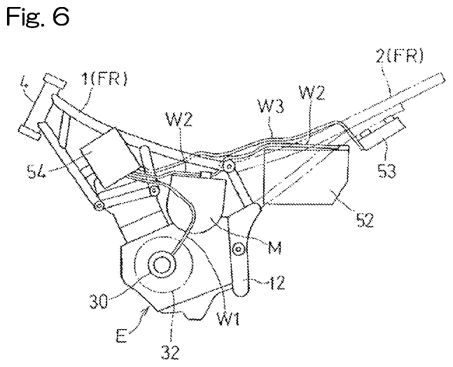

Specifically, as shown in FIG. 6, the first wire W1 extends rearward from the inverter 54 and then is bent so as to extend downward and be connected to the generator 30. The second wire W2 is connected to the battery 52 for the motor via the motor M. That is, the second wire W2 extends rearward from the inverter 54 to be connected to a terminal of the motor M, then extends inward in the vehicle widthwise direction, and thereafter is bent so as to extend rearward and be connected to the battery 52 for the motor. The third wire W3 extends rearward from the inverter 54 to be connected to the battery 53 for the control.

Thus, output of the generator 30 shown in FIG. 1 is supplied to the battery 52 through the inverter 54, so that the battery 52 is charged. Specifically, the generator 30 is an alternating current (AC) generator whose output is converted into direct current (DC) power by the inverter 54 before being supplied to the driving battery 52. The power charged in the battery 52 is supplied to the motor M to drive the motor M. In electric and hybrid driving modes, a driving force of the motor M causes the engine output shaft OS to rotate, and the driving force is transmitted to the rear wheel 16 through the power transmission member 18. In addition, when the engine E is started, power is supplied from the battery 52 to the generator 30, and the generator 30 functions as a starter.

Output of the generator 30 is supplied, with the voltage lowered by the inverter 54, to the control battery 53 which has a lower voltage than the voltage of the driving battery 52. The inverter 54 of the present embodiment tends to have a larger size than a conventional regulator because the inverter supplies power to the driving battery 52 which has a higher voltage than the voltage of the control battery 53.

The inverter 54 is disposed behind the head pipe 4, above the crankcase 22 and below the fuel tank 38. In a side view, the inverter 54 is disposed forward with respect to the axis A1 of the crankshaft 20. The inverter 54 is arranged in a region surrounded by the main frame 1, the first frame piece 25, the second frame piece 26 and the first connecting member 29 in a side view. The inverter 54 is located on the cylinder axis AX in a side view.

The inverter 54 is disposed on the outer side in the vehicle widthwise direction with respect to the crankcase 22 of the engine E. In the present embodiment, the inverter 54 is disposed on the outer side in the vehicle widthwise direction with respect to the cylinder head 24 and, in a side view, the lower half of the inverter 54 overlaps with a cylinder head cover 24b.

The inverter 54 is disposed forward of the knee grip parts 48a shown in FIG. 2. The inverter 54 is disposed on the outer side in the vehicle widthwise direction with respect to the main frame 1 in a plan view. The inverter 54 is disposed on an inner side with respect to the outer end 32a of the generator cover 32 in the vehicle widthwise direction in a plan view.

In the vehicle widthwise direction, the inverter 54 is disposed on an opposite side to the exhaust muffler 36 with respect to the center axis C1 of the vehicle body extending in the front-to-rear direction. That is, the inverter 54 is disposed on the left side of the vehicle body, and the exhaust muffler 36 is disposed on the right side of the vehicle body.

As shown in FIG. 3, the inverter 54 is disposed on the inner side of the cowling 46. This makes it possible to prevent the inverter 54 from coming into contact with an external object and achieve waterproofing of the inverter 54. This also improves the external appearance because the support part and the wiring part of the inverter 54 are not exposed to the outside.

In the plan view shown in FIG. 2, the front part of the inverter 54 protrudes forward with respect to the bending parts of the main frame 1. The inverter 54 extends in the front-to-rear direction so as to extend along the parts of the main frame 1 extending rearward from the bending parts P in a plan view. The inverter 54 is located forward of the middle portion of the fuel tank 38 in the front-to-rear direction. More specifically, the inverter 54 is located forward of the most bulged part of the fuel tank 38 in the vehicle widthwise direction.

As shown in FIG. 1, the lower end of the inverter 54 is located below the upper end of the engine E, and the upper end of the inverter 54 is located above the upper end of the engine E. In the present embodiment, the inverter 54 is located above the cylinder 23 and the cylinder head 24. Specifically, the inverter 54 is disposed outward in the vehicle widthwise direction with respect to the cylinder head cover 24b located above the cylinder head 24.

The inverter 54 is disposed rearward of the radiator 35. Specifically, the inverter 54 is disposed adjacent to the radiator 35 in the front-to-rear direction and behind and diagonally above the radiator 35. As shown in FIG. 2, the inverter 54 is disposed outward of the radiator 35 in the vehicle widthwise direction in a plan view. The incoming wind A past the radiator 35 passes through the inside of the inverter 54 in the lower part thereof, so that temperature rise of the inverter 54 can be prevented.

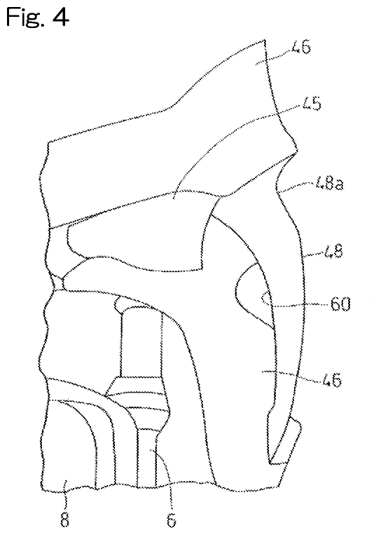

As shown in FIG. 3, the inverter 54 is disposed in the vicinity of the exhaust air port 46a of the cowling 46. In the present embodiment, a part of the inverter 54 overlaps with the exhaust air port 46a in a side view. An air intake opening 60 is defined in a part of the cowling 46 forward of the inverter 54. In the present embodiment, as shown in FIG. 4, one air intake opening 60 is defined in the front side of the cowling 46. The air intake opening 60 of the present embodiment is formed so as to expand inward in the vehicle widthwise direction from the boundary between the cowling 46 and the knee grip cover 48. However, the number, the shape and the position of the air intake opening 60 are not limited to those of this example.

When the motorcycle is travelling, the incoming wind A shown in FIG. 3 is taken in from the air intake opening 60 to the inside of the cowling 46. The incoming wind A taken into the inside of the cowling 46 cools the inverter 54 and is then discharged from the exhaust air port 46a to the outside of the cowling 46. Thus, in the present embodiment, the incoming wind A cools the inverter 54, so that operation of the inverter 54 is stabilized.

The inverter 54 is supported by the first engine support part 27 and the second engine support part 28 of the vehicle body frame FR shown in FIG. 1. Specifically, as shown in FIG. 5, the first frame piece 25 which is the first engine support part 27 is provided with a first bracket 62, and the second frame piece 26 which is the second engine support part 28 is provided with a second bracket 64. The first and second brackets 62, 64 are metal plate members and are joined, for example by welding, to the first and the second frame pieces 25, 26, respectively.

To the front and rear insertion holes 56, 56 of the main body case 55 of the inverter 54, fastening members 65 such as bolts are inserted from the outer side in the vehicle widthwise direction and are fastened to threaded holes of the first and second brackets 62, 64. The threaded holes are, for example, provided by weld nuts. Thus, the inverter 54 is removably attached to the vehicle body frame FR. However, the support structure for the inverter 54 is not limited to this.

For example, a bracket may be used to attach the inverter 54 to the vehicle body frame FR. In particular, first, the inverter 54 may be fixed to the bracket, and then the bracket may be attached to the vehicle body frame FR. A dumper for absorbing impact may be added between the vehicle body frame FR and the inverter 54.

According to the above-mentioned configuration, the inverter 54 is disposed behind the head pipe 4, above the crankcase 22 and below the fuel tank 38 as shown in FIG. 1. In a side view, the inverter 54 is disposed forward of the axis A1 of the crankshaft 20. Thus, the inverter 54 can be disposed compactly in a limited space within the saddle riding vehicle.

As can be seen from FIG. 2, the inverter 54 is disposed outward of the crankcase 22 in the vehicle widthwise direction. This can reduce the distance in the vehicle widthwise direction between the generator 30 disposed at the axial end of the crankshaft 20 and the inverter 54 disposed outward of the crankcase 22 in the vehicle widthwise direction, so that the first wire M1 can be shortened, which is the power cable between the generator 30 and the inverter 54 as shown in FIG. 6.

The battery 52 in FIG. 1 is disposed below the seat 40 and above the crankcase 22. This can reduce the gap in the vertical direction between the inverter 54 and the battery 52 disposed above the crankcase 22, so that the second wire M2 can be shortened, which is the power cable between the inverter 54 and the battery 52 as shown in FIG. 6.

The inverter 54 is disposed forward of the knee grip parts 48a as shown in FIG. 2. This can prevent the inverter 54 from interfering with the knee of a rider riding on the motorcycle.

As shown in FIG. 5, the inverter 54 has a rectangular shape in a side view, and the rear side 55r of the inverter 54 extends rearward in an inclined manner from the upper end to the lower end. As shown in FIG. 3, the rear side 55r faces the front edge 48f of the knee grip cover 48 with a gap in the front-to-rear direction therebetween, and extends parallel to the front edge 48f of the knee grip cover 48. This can prevent the inverter 54 from interfering with the knee of a rider riding on the motorcycle.

As shown in FIG. 5, the inverter 54 is disposed outward of the main frame 1 in the vehicle widthwise direction. Thus, the inverter 54 can avoid interfering with other components disposed inside the main frame 1.

The inverter 54 is supported by the first engine support part 27 and the second engine support part 28 of the vehicle body frame FR. By supporting the front and rear parts of the inverter 54 by the engine support parts 27, 28, the inverter 54 can be firmly supported on the vehicle body frame FR.

As shown in FIG. 2, in the vehicle widthwise direction, the inverter 54 is disposed on the opposite side to the exhaust muffler 36 with respect to the center axis C1 of the vehicle body extending in the front-to-rear direction. This can suppress influence of exhaust heat from the exhaust muffler 36 on the inverter 54.

The inverter 54 is disposed inward of the outer end 32a of the generator cover 32 in the vehicle widthwise direction in a plan view. This can prevent the inverter 54 from damaging when the vehicle body falls over.

The inverter 54 is preferably disposed in an area around which fewer interfering objects are located and which allows easy installation of the inverter even if the inverter 54 also provides the function of a DC-DC converter and the like and thus has an increased size. In the present embodiment, the inverter 54 has the function of a DC-DC converter. However, the inverter 54 may have the function of other electrical accessories such as a relay device and a fuse.

Since the inverter 54 is disposed outward of the vehicle body frame FR in the vehicle widthwise direction, the inverter 54 can be located closer to the outer surface of the vehicle body than in the case where the inverter 54 is disposed inward of the vehicle body frame FR in the vehicle widthwise direction, and thus temperature rise of the inverter 54 can be suppressed. Since the inverter 54 is disposed on the left side, i.e., opposite to the right side on which the exhaust pipe 34 extends, influence of heat from the exhaust pipe 34 can be suppressed, and thus temperature rise of the inverter 54 can be suppressed.

The inverter 54 has a box-like shape and is disposed in such a way that the thickness direction of the inverter coincides with the vehicle widthwise direction. This makes it possible to mount the inverter 54 while preventing the vehicle body having an increased size in the vehicle widthwise direction. The inverter 54 is disposed in such a way that the rectangular body of the inverter 54 has sides along the extension direction of the main frame 1. This makes it possible to suppress protrusion from the main frame 1 and easily support the inverter 54 on the main frame 1. The inverter 54 has a part protruding forward with respect to the bending parts P of the main frame 1. The protruding part extends toward the front and away from the main frame 1, so that the protruding part can make a gap between the main frame 1 and the inverter 54 in the vehicle widthwise direction. Flow of the incoming wind into such a gap can further improve cooling performance.

In the present embodiment, the inverter 54 has a rectangular shape in a side view, and the front side and the rear side of the inverter 54 extend substantially along the cylinder axis. This makes it possible to easily support the inverter 54 on the vehicle body frame FR along the frame parts 25, 26 supporting the engine E. Since the connectors 58 are provided on the lower side of the inverter 54, accumulation of rainwater and the like at the connectors 58 can be prevented.

In the present embodiment, the driving battery 52 is disposed below the seat 44 and below the fuel tank 38, and the inverter 54 is disposed at a substantially same position as the driving battery 52 in the vertical direction. In other words, the inverter 54 and the driving battery 52 partially overlap in a front view of the vehicle body. This makes it possible to further shorten the cable connecting the inverter 54 to the battery 52.

In the present disclosure, as described above, the inverter 54 may be disposed outward of the crankcase 22 of the engine E in the vehicle widthwise direction. According to this configuration, the distance in the vehicle widthwise direction between the inverter 54 and the generator 30 disposed at the axial end of the crankshaft 20 can be reduced to shorten the power cable between the inverter 54 and the generator 30.

The battery 52 may be disposed below the seat 40 on which a driver sits and above the crankcase 22 of the engine E. According to this configuration, the gap between the battery 52 and the inverter 54 in the vertical direction can be reduced to shorten the power cable between the battery 52 and the inverter 54.

The inverter 54 may be disposed forward of the knee grip part 48a. This configuration can prevent the inverter 54 from interfering with the knee of a driver riding on the vehicle.

In this case, the inverter 54 may have a rectangular shape in a side view and may have a side extending rearward in an inclined manner from the upper end to the lower end.

The inverter 54 may be disposed forward of the axis of the crankshaft 20 in a side view. According to this configuration, the inverter 54 can be disposed compactly in a limited space within the saddle riding vehicle.

The inverter 54 may be disposed outward of the main frame 1 of the vehicle body in the vehicle widthwise direction. According to this configuration, the inverter 54 can avoid interfering with other components disposed inside the main frame 1.

The vehicle body frame FR may include a first engine support part 27 which supports a front portion of the cylinder 23 of the engine E and a second engine support part 28 which supports a rear portion of the cylinder 23, and the inverter 54 may be supported by the first engine support part 27 and the second engine support part 28 of the vehicle body frame FR. According to this configuration, the front and rear parts of the inverter 54 can be firmly supported on the vehicle body frame FR by the first and second engine support parts 27, 28.

The inverter 54 may be disposed on an opposite side to the exhaust muffler 36 on the outer side of the vehicle body in the vehicle widthwise direction with respect to the center axis of the vehicle body extending in the front-to-rear direction. This configuration can suppress influence of exhaust heat from the exhaust muffler 36 on the inverter 54.

An outer end of the inverter 54 in the vehicle widthwise direction may be disposed, in a plan view, inward of an outer end of the generator cover 32 in the vehicle widthwise direction which covers the generator 30 from the outer side in the vehicle widthwise direction. This configuration can prevent the inverter 54 from damaging when the vehicle body falls over.

The generator 30 of the present embodiment is an ISG (Integrated Starter Generator) motor as described above and solely realizes the functions as a starter motor for starting and a generator for power generation. The generator 30 is realized as a three-phase alternating current motor and can generate a driving force to rotate the crankshaft 20 when the engine E is started. The generator 30 is configured to operate at a higher voltage (e.g., 48 V) than the voltage for operating other actuator(s) and/or sensor(s) (e.g., 12 V).

The inverter 54 of the present embodiment is connected to the generator 30 which is a three-phase alternating current motor through three high-voltage cables. The inverter 54 of the present embodiment is connected to a high-voltage battery through two high-voltage cables. The inverter 54 converts a direct current from the high-voltage battery into three-phase alternating current with mutually different phases before supplying the current to the generator 30. The inverter 54 changes the current and the frequency of the current to be supplied to the motor M in response to a motor control command given from a control device. When the three-phase alternating current is supplied from the generator 30, the inverter 54 rectifies and converts the current into direct current to supply it to the high-voltage battery 52. Therefore, the inverter 54 of the present embodiment includes an inverter circuit that converts direct current into three-phase alternating current, a converter circuit that converts three-phase alternating current into direct current, and a control circuit that controls the individual circuits so as to change the state of current to be produced in response to a command from the control device. Thus, the inverter 54 of the present embodiment has a complicated function, so that it has a relatively large size. In addition, because larger current flows in the inverter 54, the inverter 54 tends to produce a larger amount of heat than other components in which smaller current flows.

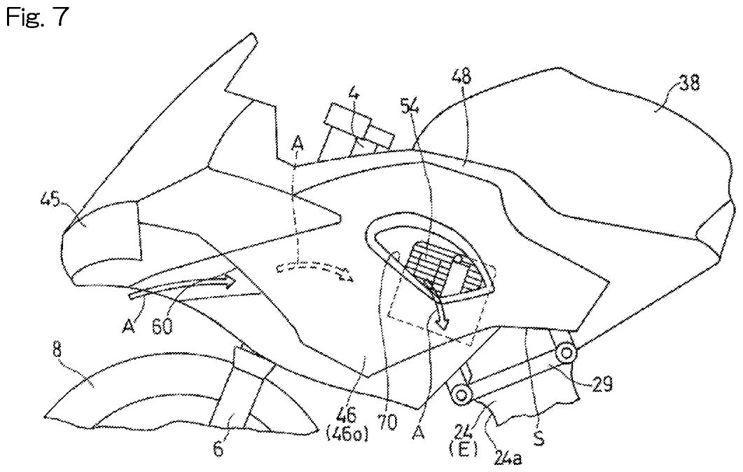

FIG. 7 to FIG. 11 show a second embodiment of the present disclosure. The second embodiment differs from the first embodiment mainly in the arrangement of the inverter 54 and part of the shape of the cowling 46. In the following description of the second embodiment, the same reference signs are used to denote the same features as those of the first embodiment, and the detailed description thereof is omitted.

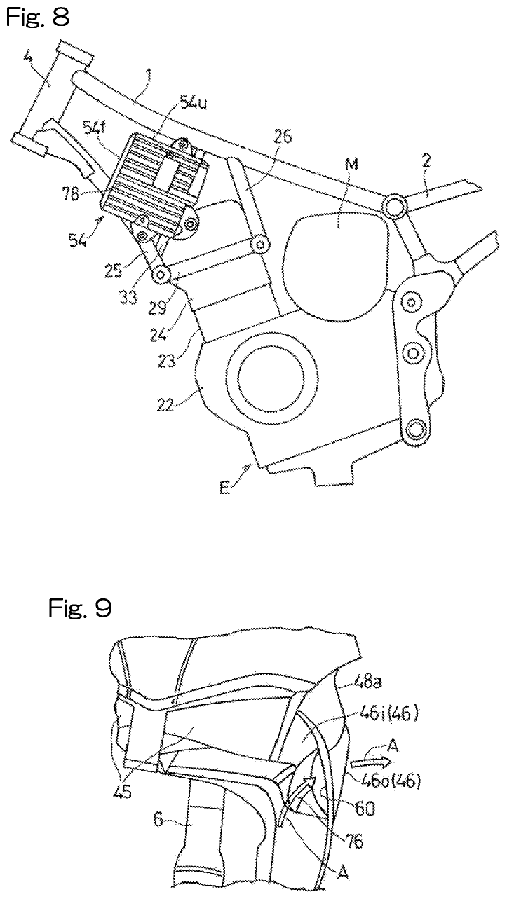

As shown in FIG. 7, the front end of the inverter 54 is located forward of the front end of the cylinder 23 of the engine E in a side view. More specifically, in the present embodiment, as shown in FIG. 8, the front side 54f of the rectangular inverter 54 extends downward in a forwardly inclined manner from the upper end, the upper piece 54u extends rearward in a downwardly inclined manner from the front end, and the entirety of the front side 54f is located forward of the front end of the cylinder head 24.

In the present embodiment, the entirety of the inverter 54 is located forward of the front end of the cylinder 23. Thus, by disposing the inverter 54 forward of the cylinder 23, the inverter 54 is disposed away from the engine E toward the upstream side in the travelling direction. Thus, the inverter 54 is less subjected to influence of hot air from the engine E while driving. The inverter 54 is disposed above and outward of the exhaust port 24a in the vehicle widthwise direction. By disposing the inverter 54 away from the exhaust port 24a, the inverter 54 can be less subjected to influence of radiant heat due to the exhaust.

As shown in FIG. 8, the front end of the inverter 54 is located forward of the front end of the engine E, as compared with the first embodiment. The inverter 54 is disposed between the main frame 1 located above and the lower first frame piece 25 located below, and the upper and lower portions of the inverter 54 are fixed by both of the upper and lower frames 1, 25. The inverter 54 is disposed adjacent to the connecting member 33 which connects the upper and lower frames 1, 25. This makes it possible to increase support rigidity of the inverter 54. In the present embodiment, the connecting member 33 extends in the vertical direction along the direction in which the inverter 54 extends in the vertical direction. Since the inverter 54 is disposed in an inclined manner in a side view, the lower end portion can be located forward as much as possible so as to make it easier to avoid interfering with the knee part of a driver.

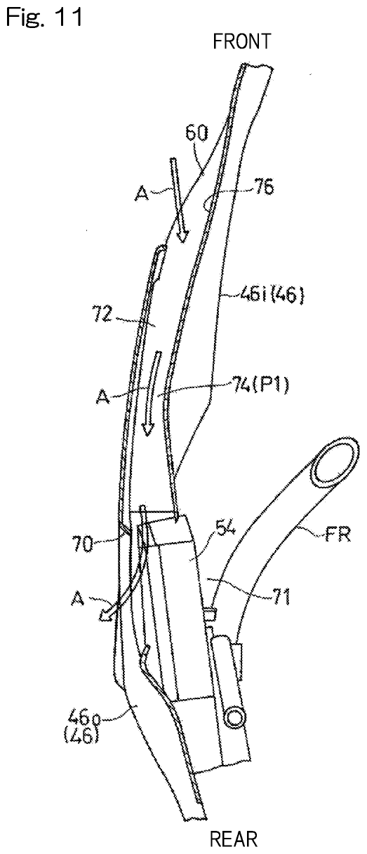

As shown in FIG. 7, in the present embodiment, the structure of the exhaust air port 70 of the cowling 46 is partially different from that in the first embodiment. The inverter 54 is disposed outward of the vehicle body frame FR in the vehicle widthwise direction and inward of the cowling 46 in the vehicle widthwise direction, and the exhaust air port 70 is located in an area which faces the inverter 54 in the vehicle widthwise direction in the cowling 46. Below the exhaust air port 70, a lower opening 71 (FIG. 11) is defined, which communicates the space for receiving the inverter 54 with the lower space.

As shown in FIG. 9, the cowling 46 has the air intake opening 60 at the front end portion. The cowling 46 includes an air passage 72 from the air intake opening 60 to the inverter 54 inside the cowling 46. In the present embodiment, the cowling 46 includes an inner cowl 46i which is attached to the vehicle body frame FR and an outer cowl 46o which is attached to the outside of the inner cowl 46i in the vehicle widthwise direction, and the air passage 72 is defined between these cowls 46i, 46o.

The air intake opening 60 is located outward of the cowling 46 in the vehicle widthwise direction. This makes it possible to take in the incoming wind A which collides with the front end of the cowling 46 and/or the headlight 45 and flows in the outside in the vehicle widthwise direction, and to guide it toward the inverter 54. The inner cowl 46i which defines a part of the air intake opening 60 is shaped so as to recessed inward in the vehicle widthwise direction and thereby can provide the air intake opening 60 to increase the amount of the incoming wind A to be taken in. The inner cowl 46i bulges outward in the vehicle widthwise direction from the front end to the rear, so that the inner cowl 46i can more easily prevent undesired exposure of the inner structure of the vehicle body when viewed from the front.

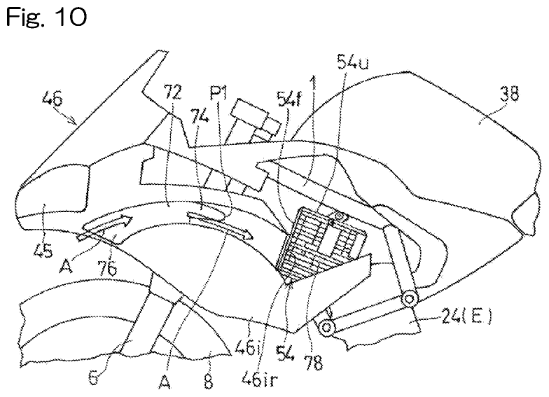

As shown in FIG. 11, the air passage 72 includes, on the upstream side with respect to the inverter 54, a nozzle part 74 in which the passage area is reduced as compared with the passage area on the inlet side. Specifically, as shown in FIG. 10, the rear edge 46ir of the inner cowl 46i faces the front side 54f of the inverter 54 in the front-to-rear direction. In the present embodiment, the rear edge 46ir of the inner cowl 46i and the front side 54f of the inverter 54 are to parallel and do not overlap in a side view. That is, the inner cowl 46i and the inverter 54 are arranged next to each other in the front-to-rear direction, and the inverter 54 is covered by the outer cowl 46o from the outer side in the vehicle widthwise direction. The exhaust air port 70 is located in the outer cowl 46o.

A recessed groove 76 which is recessed inward in the vehicle widthwise direction is provided on the outer surface of the inner cowl 46i. The recessed groove 76 extends in the front-to-rear direction from the front edge of the inner cowl 46i to the middle point P1 in the front-to-rear direction. The recessed groove 76 is recessed most at the front edge and is recessed least at the middle point P1 in the front-to-rear direction. That is, the recessed amount of the recessed groove 76 gradually decreases from the front edge to the rear. The part of the inner cowl 46i located rearward with respect to the middle point P1, i.e., the part located between the middle point P1 and the inverter 54 is inclined inward in the vehicle widthwise direction to the rear.

Therefore, as shown in FIG. 11, the passage area of the air passage 72 between the inner cowl 46i and the outer cowl 46o is largest at the air intake opening 60, gradually decreases toward the middle point P1 to be smallest at the middle point P1, and then gradually increases from the middle point P1 toward the inverter 54 located behind. That is, the nozzle part 74 is located at the middle point P1 of the air passage 72.

According to the air passage 72 having such a configuration, the air intake opening 60 extends in an inclined manner with respect to the vehicle widthwise direction, with the inner end of the air intake opening in the vehicle widthwise direction located forward with respect to the outer end of the air intake opening in the vehicle widthwise direction. Thus, the air intake opening 60 can be made relatively large in relation to the passage cross-sectional area, so that a large amount of incoming wind can be taken into the air passage 72. The flow speed of the incoming wind A introduced into the air passage 72 gradually increases toward the nozzle part 74. The incoming wind A past the nozzle part 74 flows in a diffused manner toward the inverter 54 located behind. Thus, the incoming wind A having an increased flow speed collides with the inverter 54.

The inverter 54 includes, as shown in FIG. 10, a plurality of cooling fins 78 on the outer surface. The individual cooling fins 78 extend along the upper piece 54u of the inverter 54. In the present embodiment, the individual cooling fins 78 extend parallel to the upper piece 54u. The cooling fins 78 extend in a direction perpendicular to the front side 54f of the inverter 54, i.e., in a direction perpendicular to the rear edge 46ir of the inner cowl 46i. Therefore, the incoming wind A guided by the inner cowl 46i flows along the cooling fins 78 of the inverter 54.

According to the second embodiment, the front end of the inverter 54 is located forward of the front end of the cylinder 23 in the side view of FIG. 8. This makes it easier to dispose the inverter 54 forward of the knee grip part 48a (FIG. 7) and thereby makes it possible to prevent the inverter 54 from interfering with the knee of a rider. In addition, by disposing the inverter 54 away from the cylinder 23, the inverter 54 can be less subjected to influence of radiant heat from the cylinder 23.

As shown in FIG. 11, the inverter 54 is disposed outward of the vehicle body frame FR in the vehicle widthwise direction and inward of the cowling 46 in the vehicle widthwise direction. Thus, the inverter 54 is disposed inward of the outer surface of the vehicle body, so that the inverter 54 can be protected from contact with a person or an object located outside.

The cowling 46 includes the exhaust air port 70 in an area opposite to the inverter 54 shown in FIG. 7 in the vehicle widthwise direction. This makes it possible to form the flow of the incoming wind A to be discharged through the exhaust air port 70 and makes it easy to dispose the inverter 54 in the flow of the incoming wind A. The incoming wind A past the exhaust air port 70 flows outward in the vehicle widthwise direction and away from the vehicle body. Thus, it is possible to prevent hot air from the inverter 54 from flowing toward the driver and thereby reduce the driver's discomfort.

Further, since hot air flows outward from the exhaust air port 70, it is possible to prevent accumulation of heat from the inverter 54 inside the cowling 46 while the vehicle is parked. In particular, the exhaust air port 70 is arranged so as to face the upper side of the inverter 54, so that hot air heated by the inverter 54 and accumulating above the inverter 54 can be easily discharged. Furthermore, the lower opening 71 which communicates the air passage 72 with the lower space is provided below the inverter 54, so that the lower opening 71 can facilitate introduction of fresh air and suppress temperature rise around the inverter 54 while the vehicle is parked.

The cowling 46 further includes the air intake opening 60 in the front end portion of the cowling 46. Thus, the incoming wind enters from the air intake opening 60 into the inside of the cowling 46 and is discharged from the exhaust air port 70 to the outside of the cowling 46 in the vehicle widthwise direction. The incoming wind cools the inverter 54 and causes hot air to flow away from the rider. The inverter 54 has a control function for adjusting output of the motor M and adjusting the generator 30 and includes a control circuit board and/or an integrated circuit incorporated therein. Therefore, the inverter 54 has more stringent heat requirements than those for analog circuit components such as a regulator. According to the above-mentioned configuration, the inverter 54 can be effectively cooled by the incoming wind.

As shown in FIG. 11, the cowling 46 includes the air passage 72 which extends toward the inverter 54 thereinside, and the air passage 72 includes the nozzle part 74 where the passage area is reduced on the upstream side of the inverter 54. Thus, the flow speed of the incoming wind is increased in the nozzle part 74, so that the cooling effect during driving can be enhanced.

The present disclosure is not limited to the above-described embodiments, and various additions, modifications, or deletions may be made without departing from the scope of the present disclosure. For example, although the above embodiments are described with reference to motorcycles, the present disclosure can also be applied to saddle riding vehicle other than motorcycles, such as three-wheelers and four-wheeled buggies.

The present disclosure can also be applied to series hybrid vehicles as well as parallel hybrid vehicles. In particular, the present disclosure may be suitably applied to vehicles including an ISG motor. The present disclosure may also be applied to engine vehicles including an ISG motor. The vehicle body frame is not limited to a pipe frame and may be a die cast frame. Further, the inverter 54 may not necessarily have a function other than the inverter function, such as a DC-DC converter function. The orientation of the inverter 54 is not limited to the above-described configuration. For example, the inverter may have, in a side view, a rectangular shape having two sides extending in the vertical direction and two sides extending in the front-to-rear direction, with the connectors 58 provided to the rear side.

Further, the position of the inverter 54 is not limited to that of the above embodiment, and the inverter 54 may be attached at a different position from that of the above embodiment. The present disclosure can be applied not only to hybrid vehicles, but also electric vehicles. Accordingly, such variants are included within the scope of the present disclosure.

What is claimed is:

1. A saddle riding vehicle comprising:
an engine disposed between a front wheel and a rear wheel;
a fuel tank disposed above the engine;
a generator mounted to a crankshaft of the engine; and
an inverter that supplies output of the generator to a battery,
wherein the inverter is disposed behind a head pipe, above a crankcase and below the fuel tank.

2. The saddle riding vehicle as claimed in claim 1, wherein the inverter is disposed outward of the crankcase of the engine in a vehicle widthwise direction.

3. The saddle riding vehicle as claimed in claim 1, further comprising a seat on which a driver sits, wherein
the battery is disposed below the seat and above the crankcase of the engine.

4. The saddle riding vehicle as claimed in claim 1, further comprising a cowling which covers a front part of a vehicle body from an outer side in a vehicle widthwise direction,
wherein a part of the cowling located rearward of the inverter constitutes a knee grip part.

5. The saddle riding vehicle as claimed in claim 4, wherein the inverter has a rectangular shape in a side view and has a side extending rearward in an inclined manner from an upper end of the inverter to a lower end of the inverter.

6. The saddle riding vehicle as claimed in claim 1, wherein the inverter is disposed forward of an axis of the crankshaft in a side view.

7. The saddle riding vehicle as claimed in claim 6, wherein a front end of the inverter is located forward of a front end of a cylinder of the engine in a side view.

8. The saddle riding vehicle as claimed in claim 1, wherein the inverter is disposed outward of a main frame of a vehicle body in a vehicle widthwise direction.

9. The saddle riding vehicle as claimed in claim 1, wherein a vehicle body frame includes a first engine support part which supports a front portion of a cylinder of the engine and a second engine support part which supports a rear portion of the cylinder, and
the inverter is supported by the first engine support part and the second engine support part of the vehicle body frame.

10. The saddle riding vehicle as claimed in claim 1, wherein the inverter is disposed on an opposite side to an exhaust muffler located on an outer side of a vehicle body in a vehicle widthwise direction, with respect to a center axis of the vehicle body extending in a front-to-rear direction.

11. The saddle riding vehicle as claimed in claim 1, wherein an outer end of the inverter in a vehicle widthwise direction is disposed, in a plan view, inward of an outer end of a generator cover in the vehicle widthwise direction which covers the generator from an outer side in the vehicle widthwise direction.

12. The saddle riding vehicle as claimed in claim 1, further comprising a cowling which covers a front part of a vehicle body from an outer side in a vehicle widthwise direction,
wherein the inverter is disposed outward of a vehicle body frame in the vehicle widthwise direction and inward of the cowling in the vehicle widthwise direction.

13. The saddle riding vehicle as claimed in claim 12, wherein the cowling includes an exhaust air port in an area which faces the inverter in the vehicle widthwise direction.

14. The saddle riding vehicle as claimed in claim 13, wherein the cowling includes an air intake opening in a front end portion of the cowling.

15. The saddle riding vehicle as claimed in claim 13, wherein a lower opening which communicates with a lower space than the cowling is defined below the exhaust air port.

16. The saddle riding vehicle as claimed in claim 13, wherein the cowling includes an air passage toward the inverter inside the cowling, and
the air passage includes a nozzle part where a passage area is reduced on an upstream side of the inverter.

17. A saddle riding vehicle comprising
an engine as a driving power source;
a generator mounted to a crankshaft of the engine;
an inverter that supplies output of the generator to a battery, and
a cowling which covers a front part of a vehicle body from an outer side in a vehicle widthwise direction, wherein
the inverter is disposed outward of a vehicle body frame in the vehicle widthwise direction and inward of the cowling in the vehicle widthwise direction, and
the cowling includes an air intake opening arranged in a front end portion of the cowling and an exhaust air port arranged in an area which faces the inverter in the vehicle widthwise direction.
